(19) United States
(12) Patent Application Publication
(10) Pub. No.: US 2005/0164153 A1
(43) Pub. Date: Jul. 28, 2005

(54) Method and apparatus for providing presentation options during an on-line educational exam based upon a user's profile

(76) Inventors: Alejandra L. Beatty, Aurora, CO (US); Joel M. Sanda, Denver, CO (US)

Correspondence Address: Snell & Wilmer LLP, One Arizona Center, 400 East Van Buren, Phoenix, AZ, 85004-2202, US

(21) Appl. No.: 10/766,612

(22) Filed: Jan. 28, 2004

(51) Int. Cl. G09B 3/00

(52) U.S. Cl. 434/350; 434/362; 434/323

(57) ABSTRACT

Automatically providing for presentation options for students during an on-line exam. Each student has an individual educational plan indicating presentation options available to them. Each individual educational plan is converted into an on-line profile that controls the presentation options available to the student when taking an on-line exam having a series of questions. Based upon the profile, particular presentation options are provided to the student during the presentation of the questions for the on-line exam in order to accommodate the student's disabilities or impairments. The student can use those presentation options to help facilitate taking of the exam according to their individual educational plan.

### FIELD OF THE INVENTION

The present invention relates to a method and apparatus to provide for presentation options during an on-line educational exam based upon a corresponding user's profile.

### BACKGROUND OF THE INVENTION

The No Child Left Behind Act and the Individuals with Disabilities Education Act (IDEA) require that assistive technology be provided to those students who need it. Assistive technology includes various types of technology to assist those with disabilities, such as screen readers and voice recognition programs. Providing this type of technology will help to ensure that all students, including those with disabilities, will have the ability to receive adequate education. The No Child Left Behind Act also requires that students be tested, using assistive technology available to them, and their performance tracked.

In order to help implement the requirements of the Acts, teachers or others work with students to develop an Individual educational plan (IEP) for each one. The teachers determine what assistive technology should be provided to each student, and the IEPs thus specify what assistive technology must be provided to each student. The IEP “travels with” the student throughout his or her grade levels, and teachers in each grade level can thus know what assistive technology must be provided to each student based upon the IEPs.

Satisfying the requirements of the Acts can provide for many challenges. The various software programs that provide assistive technology must be available to the students. However, each student must only have access to the assistive technology available to him or her based upon each IEP.

Accordingly, a need exists for selectively providing presentation options to students during instructional and assessment times.

### SUMMARY OF THE INVENTION

A first method and apparatus consistent with the present invention automatically provide for presentation options during an on-line exam. The method and apparatus use an on-line profile based upon an individual educational plan for a particular student, and the on-line profile provides an indication of presentation options available to the student. An on-line exam having a plurality of questions is received, and the questions are presented to the student via an electronic screen display during the exam. Based upon the profile, the presentation options are provided to the student during the presentation of the questions for the on-line exam. The student's answers to the questions are received and stored.

A second method and apparatus consistent with the present invention convert an individual educational plan for a student into an on-line profile for use in controlling presentation options for the student. The method and apparatus use an individual educational plan for a particular student. The individual educational plan is converted into an on-line profile that controls presentation options available to the student when taking an on-line exam having a plurality of questions. During the exam, the questions are presented to the student via an electronic screen display, and the presentation options are provided to the student, as controlled by the profile. The student's answers to the questions are received and stored.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram illustrating electronically providing for presentation options during an exam;

FIG. 2 is a diagram illustrating an exemplary network for delivering on-line exams;

FIG. 3 is a diagram of exemplary components of a student computer;

FIG. 4 is a flow chart of a generate profile routine;

FIGS. 5 and 6 are a flow chart of an exam routine;

FIG. 7 is a diagram of a screen illustrating use of presentation options for learning disabilities;

FIG. 8 is a diagram of a screen illustrating use of presentation options for blind or visually impaired disabilities;

FIG. 9 is a diagram of a screen illustrating use of presentation options for disabilities involving motor impairments; and

FIG. 10 is a diagram of a screen illustrating use of presentation options for deaf or hard of hearing disabilities.

### DETAILED DESCRIPTION

### Overview

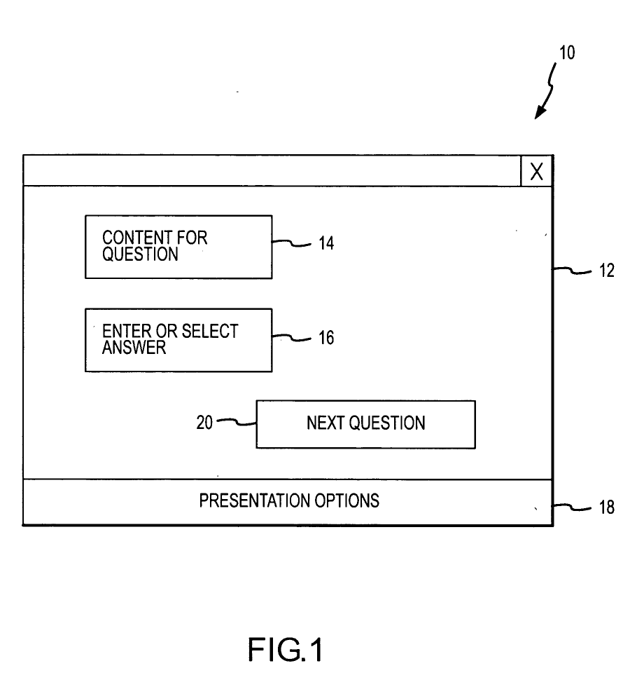

FIG. 1 is a diagram 10 illustrating a screen 12 for electronically providing for presentation options during an exam. In screen 12, a student can view a question in a section 14 and submit an answer to it in a section 16. Once an answer has been submitted, the student can select a section 20 to proceed to the next question. The term “student” is intended to include any type of user taking an exam.

The presentation options available to the student are based upon information in his or her IEP, as indicated above. The IEP is converted into an on-line profile for the student, which can control those presentation options available to the student while taking an on-line or electronic exam. Therefore, each student can be selectively provided with the presentation options available to him or her, and the system will block display of image descriptions if not specified in the student's profile, to ensure that the administering of exams to students satisfies the requirements of the No Child Left Behind Act or for other purposes. These electronic exams can be administered via an on-line educational system, an example of which is described in U.S. Pat. No. 6,470,171, which is incorporated herein by reference as if fully set forth.

Presentation options can work in conjunction with nearly any web browser technology as well as assistive technology, available to aid those who have certain types of disabilities or impairments. Examples of assistive technology include the following: the JAWS for Windows program (screen reader); the eReader program (text reader); the ZoomText program (screen magnification); the BrowseAloud/WordSmith program (text reader and input); the Read & Write/Gold program (text reader and input); the Windows-Eyes program (screen reader); the IBM HomPage Reader (screen reader); the Microsoft Windows program; the Internet Explorer Program; and any web browser/operating system. The programs for providing assistive technology options typically reside locally on a student's computer, which can be important for compatibility purposes with the operating system or other programs on the student's computer.

Additional types of presentation options using assistive technology, and a system for them it, are disclosed in U.S. patent application Ser. No. 10/061,200, entitled “Variable Types of Sensory Interaction for an On-Line Educational System,” and filed Feb. 1, 2002, which is incorporated herein by reference as if fully set forth.

As examples, the presentation options can facilitate the taking of exams for the following types of disabilities. A blind or visually impaired student can use a screen reader program to hear electronically displayed text or descriptions of figures and drawings. A visually impaired student, still having some sight, can use technology options of a browser program to increase the font size of text, use a different type of font, or change colors of the font, all of which can make it easier for the student to read text on a computer screen. A student unable to use a keyboard can use a text input (voice recognition) program to enter answers to exam questions. A hearing impaired person can have access to closed captioning for displayed videos. Other types of presentation options are also available for these or other disabilities or impairments.

### Network

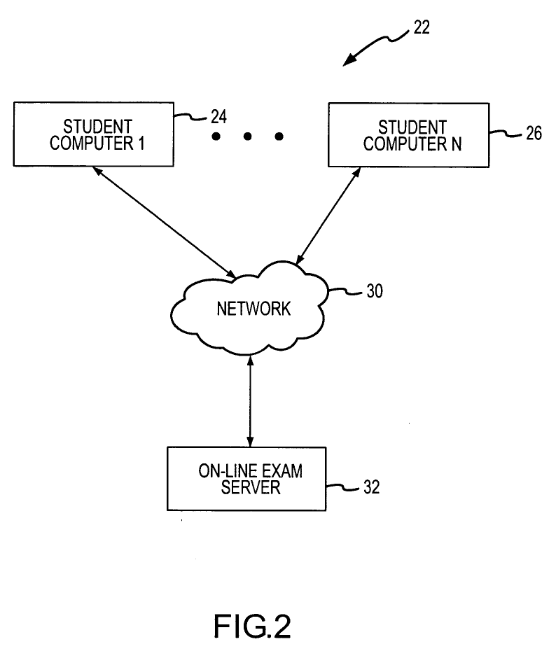

FIG. 2 is a diagram illustrating an exemplary network 22 for delivering on-line exams. Network 22 can include a plurality of student computers 24 and 26 connected to a network 30, such as the Internet, a wide area network, a local area network, or any wireless or wireline network. One or more instructors can interact with the students via the network 30 and can be physically present for monitoring during exams. The network 22 can also include one or more on-line exam servers 32, which can interact with the students and instructors via network 30. An example of such a server and a system for delivering courses on-line are described in U.S. Pat. No. 6,470,171. An on-line or local educational system can be scaled to include any number of computers and servers. The communications via network 30 can occur through any communications protocols, such as Transmission Control Protocol/Internet Protocol (TCP/IP) and the use of browsers, or through Wireless Application Protocol (WAP).

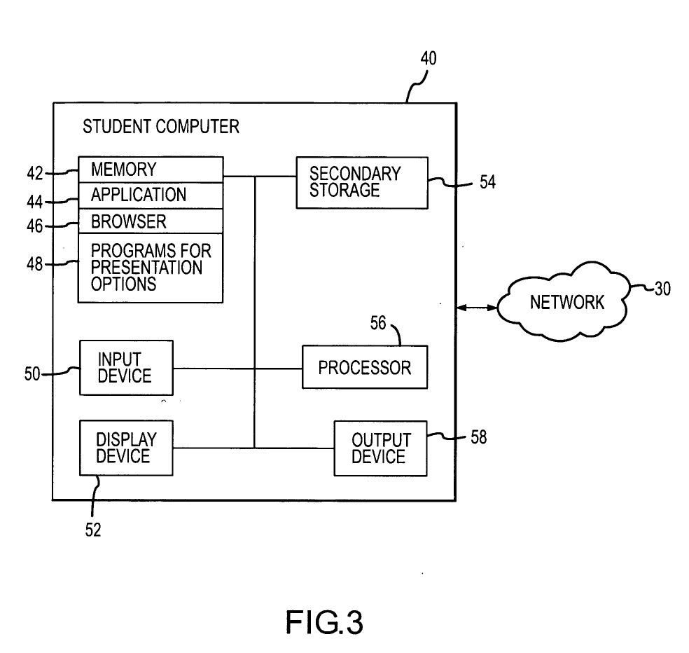

FIG. 3 is a diagram of exemplary components of a student computer 40, which can represent student computers 24 and 26. Computer 40 can include the following exemplary components: a memory 42 storing one or more applications 44, a web browser 46, and programs 48 for presentation options; an input device 50 for entering information or commands into computer 40; a display device 52 for providing a visual display of information; a secondary storage device 54; a processor 56; and an output device 58 for outputting information such as in hardcopy or audio form. The processor 56 can execute programs stored in memory 42, secondary storage 54, or received via network 30.

The software programs for implementing presentation options may reside locally on a student's machine, such as on the hard disk drive, or remotely on a server. The programs for the assistive technology can be downloaded via network 30, or from a storage medium such as a disk, and installed in a conventional manner of locally installing programs for execution. Examples of commercially available programs for implementing presentation options are provided above. Presentation options are not necessarily limited to software programs and can include other types of technology as well.

### Processing for Exams with Assistive Technology

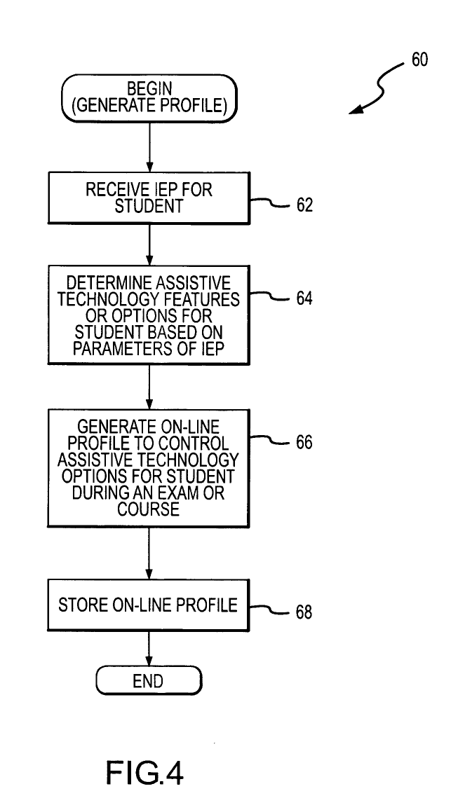

FIG. 4 is a flow chart of a generate profile routine 60. Routine 60 can be implemented in, for example, software modules for execution by server 32. In routine 60, the system receives an IEP for a student (step 62). IEPs are known in the art, and they can be manually generated for each student by instructors or others by considering each students disability or impairment, if any, and specifying the presentation options for which the student is permitted to access. Based upon parameters of the IEP, the system determines presentation options for the student corresponding with this particular IEP (step 64).

The system generates an on-line profile for the student to control use of presentation options during an exam or course (step 66). The system can store the on-line profile (step 68) in a database for use in controlling the presentation options available to the student. Routine 60 can alternatively be implemented manually, instead of using this automated process, by having a person manually enter the profile parameters based upon the student's IEP.

Table 1 conceptually illustrates a database structure for specifying an on-line profile for a student.

TABLE 1
On-Line Profile for Student X

| | | date | special |
|---|---|---|---|
| option | available? | modified | instructions |
| assistive technology option 1 | Yes/No | date 1 | |
| assistive technology option 2 | Yes/No | date 2 | |
| . | | . | |
| . | | . | |
| . | | . | |
| assistive technology option N | Yes/No | date N | |

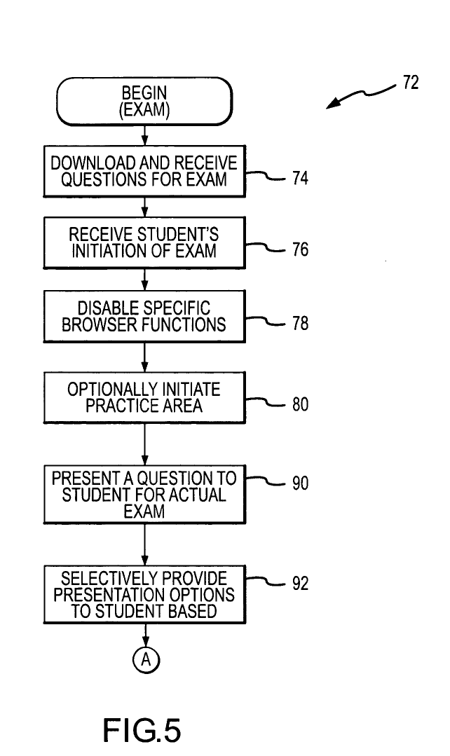

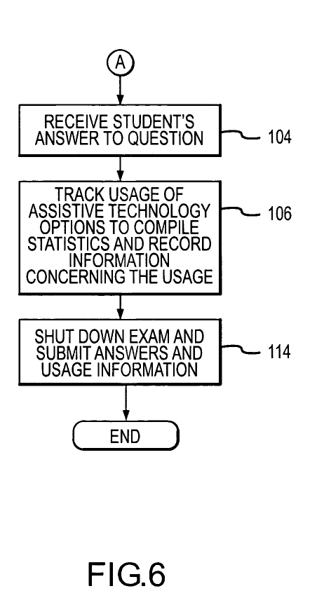

FIGS. 5 and 6 are a flow chart of an exam routine 72. Routine 72 can be implemented in, for example, software modules for execution by processor 56 in the student's computer 40 or remotely in server 32. In routine 72, a student downloads and receives questions, served up through a browser, for an exam (step 74). The questions are typically pre-generated by education experts or others for a particular subject and grade level. Server 32 receives a student's initiation of the exam (step 76) in computer 40 web browser (46). Upon starting an exam, the server 32 typically disables specific browser functions on the student's computer to prevent the student from obtaining access to presentation options not permitted for use by him or her (step 78). Other control options are possible.

Server 32 determines if it should initiate a practice area for the student (step 80). The step can be determined, for example, by a default setting requiring the student to use the practice area or allowing administrators to override requirements. The practice area replicates the actual exam with practice content items and provides the student with an area to practice answering exam questions using the presentation options available to him or her based upon the profile. The questions in the practice area are not part of the actual exam and thus are not considered in scoring of the student's exam answers; however, they can include the same questions or types of questions previously administered. If the practice area is to be initiated (step 80), server 32 launches the practice area with practice questions and selectively provides presentation options to the student based upon his or her profile.

Server 32 presents one or more questions to the student for the actual exam (step 90) on display device 52. While the student is presented with a question and submits an answer for it, server 32 selectively provides presentation options to the student based upon the student's IEP (step 92). Server 32 receives the student's answer to the presented question (step 104). The answers are typically received electronically via network 30. However, in some instances a student may be requested to handwrite an answer, such as an essay with graphs, and in that case the hard copy answer would be given to an instructor or other person administering the exam. This type of option can also be used to accommodate students who do not know how to type or having difficulty doing so.

Server 32 can also compile usage statistics of assistive technology concerning their usage and how that may potentially relate to correct or incorrect answers (step 106). Table 2 illustrates an example of how this information can be recorded and stored. In some instances, this information may actually be required by the No Child Left Behind Act. In the same manner, server 32 can optionally also track usage statistics with respect to the practice area described above.

TABLE 2

| | |
|---|---|
| student ID | exam ID |

| | presentation | time spent |
|---|---|---|
| question | option(s) used | on question |
| question 1 | option(s) 1 | time 1 |
| question 2 | option(s) 2 | time 2 |
| . | . | . |
| . | . | . |
| . | . | . |
| question N | option(s) N | time N |

When a student finishes the exam, computer 40 or server 32 shuts down the exam and submits the student's answers and usage information (e.g., in Table 2) to server 32 for recording. The usage information from step 106 can alternatively be provided in other forms, such as on a CD or other disk, or in hard copy format.

When taking an on-line exam, a student uses web browser 46 on computer 40 to move between questions on scheduled sections. As the student moves between questions, each answer is stored in server 32. When a student is finished with a testing section, he or she exits the system. The student's answers are stored for later retrieval and can be electronically submitted to an outside vendor, for example, for grading or print out.

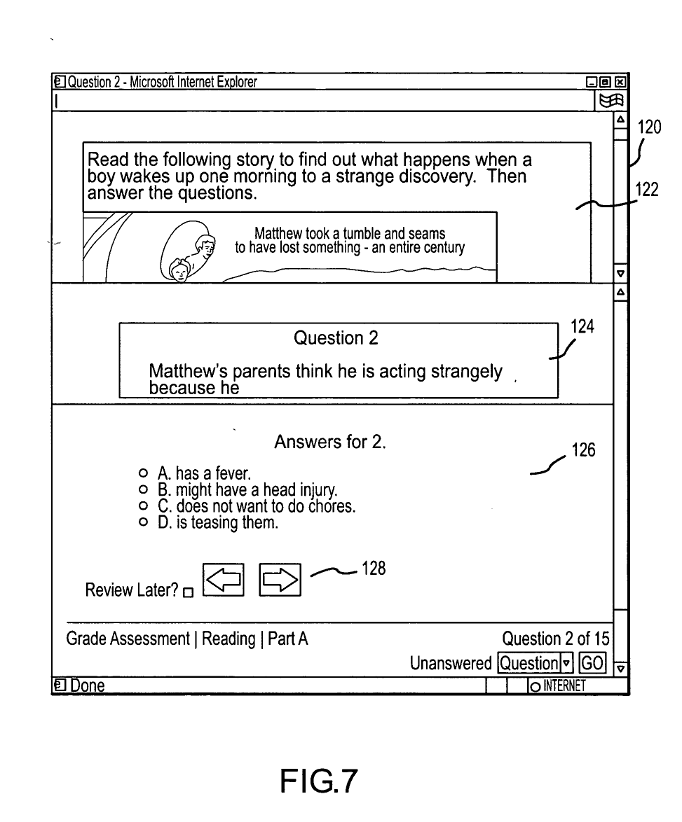

FIG. 7 is a diagram of a screen 120 illustrating use of potential presentation options for learning disabilities. Screen 120 and the others described below can be implemented in software, such as HyperText Markup Language (HTML), for display to a student on browser 46. In screen 120, a section 122 displays a story for question 124, and a student can select an answer among the choices displayed in a section 126. To accommodate a learning disability, according to a student's accommodation profile, the system can display the content for the question in multiple formats, such in a scrollable frameset, in a window pop-up, or all in one page. Text descriptions of images can be displayed for students who require prompting according to their IEP. The questions are displayed one-at-a-time to reduce “busyness” and distractions for those with attention deficit disorders and help the student focus on the question. Also, the student can modify colors for the question/answer area to help him or her remain focused. The display is designed to complement the use of other assistive technologies such as a text reader program, which sequentially highlights each word in the displayed text in order to help the student focus for those students who have an attention deficit disorder or other learning disability. The student can manipulate arrows 128, such as via a cursor-control device, to return to the previous question or advance to the next question.

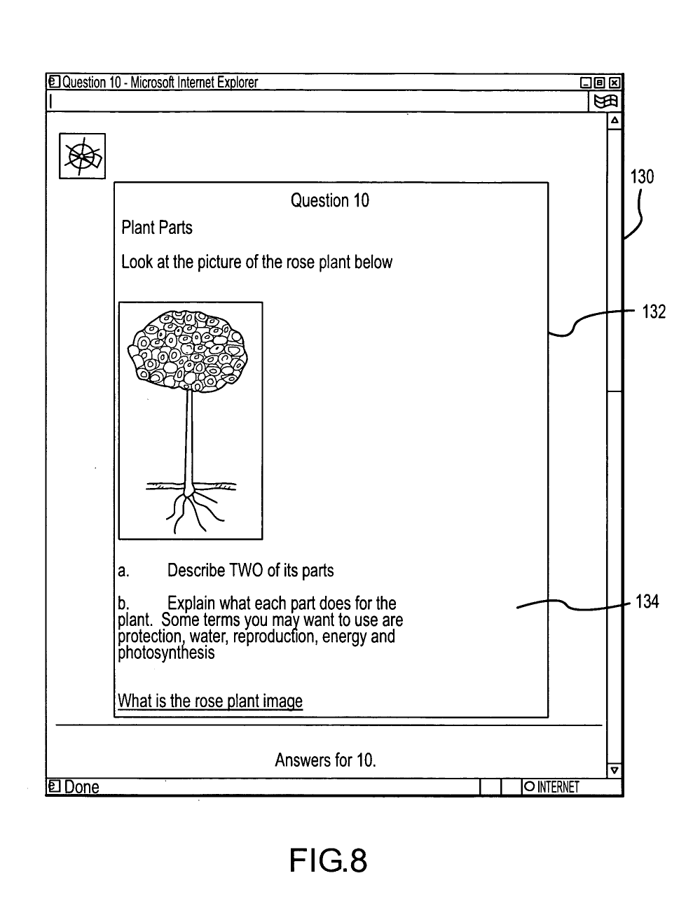

FIG. 8 is a diagram of a screen 130 illustrating use of presentation options for blind or visually impaired disabilities. In screen 130, an image is provided in a section 132 for the question provided in a section 134. Based upon profile settings, the screen can display text descriptions of the displayed image. The screen profile settings can also display page navigation prompts to allow the student to easily navigate in the page displayed in screen 130. For example, a student may use the displayed steering wheel in the left-hand top corner in the screen and also the question mark and pencil images in the bottom portion of the screen. According to a student's profile, the system can also display the content for the question in multiple formats, such in a scrollable frameset, all in one page, or in window pop-ups. The different formats may make it easier for the visually impaired student to read the content by, for example, increasing the size of text or images. The system is also designed to complement the use of screen readers to provide audio output 58 by presenting content in separate windows which allows the student to narrow the content spoken.

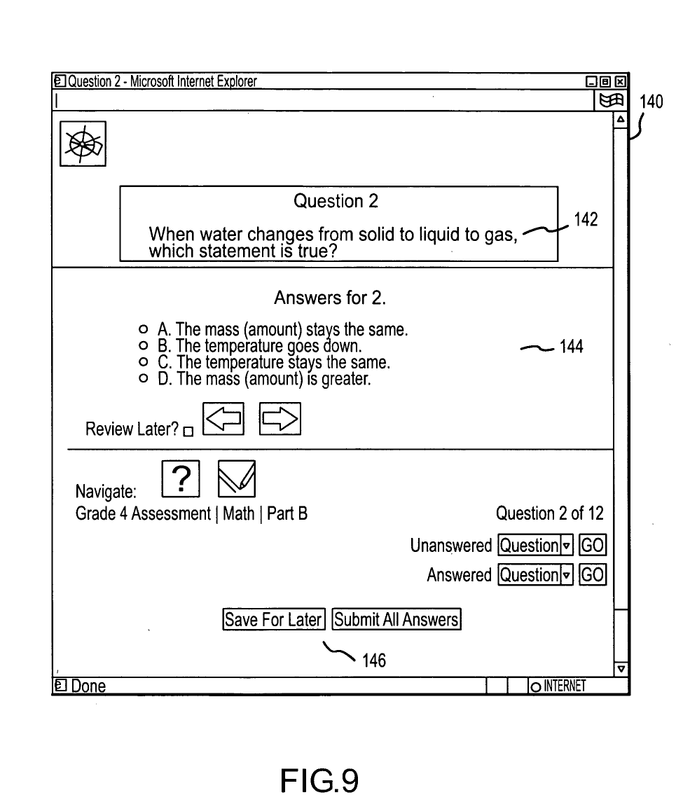

FIG. 9 is a diagram of a screen 140 illustrating use of presentation options for disabilities involving motor impairments. In screen 140, this page uses standard elements, easily navigated with a keyboard. A section 142 displays a question, and a section 144 displays choices for answers to the question. The screen can also display page navigation prompts to allow the student to easily navigate in the page displayed in screen 140. The student may optionally have access to a voice recognition program to enter answers or navigate the screen using assistive devices.

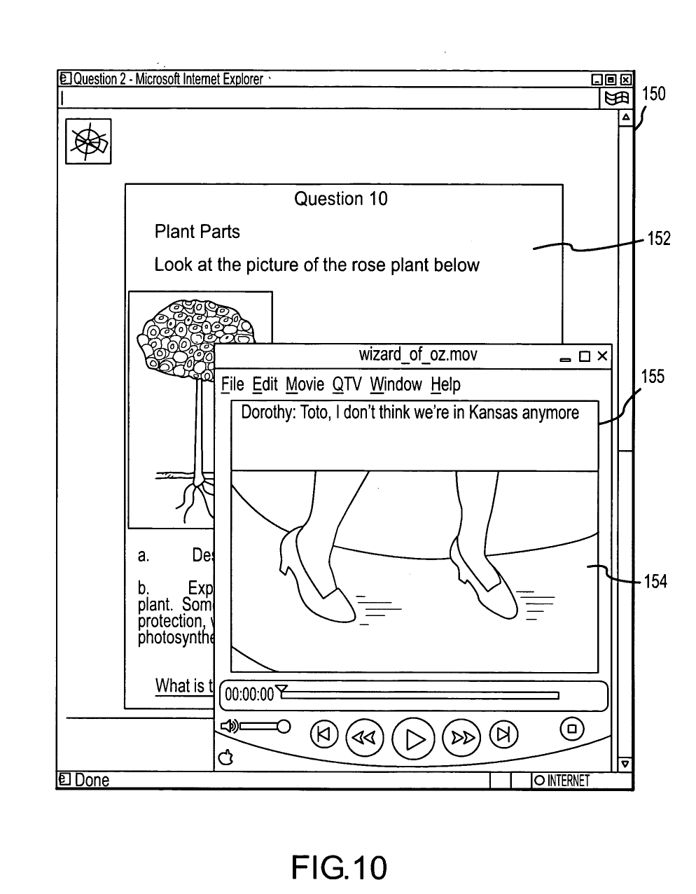

FIG. 10 is a diagram of a screen 150 illustrating use of presentation options for deaf or hard of hearing disabilities. In screen 150, a section 152 display a question. A window 154 can play a movie in conjunction with the question and, to accommodate the student, the audio portion of the movie can be provided in closed captioning, as shown in a section 155.

Other types of presentation options are available for the disabilities referred to with respect to FIGS. 7-10 and those presented are intended as examples only. For example, a student may be given access to a help page providing instructions for the student to select display preferences such as font sizes, font colors, types of fonts, volume, and foreground or background colors.

While the present invention has been described in connection with an exemplary embodiment, it will be understood that many modifications will be readily apparent to those skilled in the art, and this application is intended to cover any adaptations or variations thereof. For example, computers, interfaces, and assistive technology programs may be used without departing from the scope of the invention. This invention should be limited only by the claims and equivalents thereof.

1. A method for automatically providing presentation options during an on-line exam, comprising:
receiving an on-line profile based upon an individual educational plan for a particular student, the on-line profile providing an indication of presentation options available to the student;
receiving an on-line exam having a plurality of questions;
presenting the questions to the student via an electronic screen display;
providing the presentation options to the student, based upon the profile, during the presentation of the questions for the on-line exam; and
receiving answers to the questions and storing the answers.

2. The method of claim 1 wherein the receiving the on-line profile step includes receiving parameters specifying the permitted presentation options for the particular student.

3. The method of claim 1, further including compiling data relating to use of the presentation options and performance of the student in submitting answers to the questions.

4. The method of claim 1, further including providing a practice area for the student to submit answers to practice questions, not part of the on-line exam, using the presentation options.

5. A method for converting an individual educational plan for a student into an on-line profile controlling presentation options for the student, comprising:
receiving an individual educational plan for a particular student;
converting the individual educational plan into an on-line profile that controls presentation options available to the student when taking an on-line exam;
receiving the on-line exam having a plurality of questions;
presenting the questions to the student via an electronic screen display;
providing presentation options to the student, as controlled by the profile, during the presentation of the questions for the on-line exam; and
receiving answers to the questions and storing the answers.

6. An apparatus for automatically providing presentation options during an on-line exam, comprising:
a module configured to receive an on-line profile based upon an individual educational plan for a particular student, the on-line profile providing an indication of presentation options available to the student;
a module configured to receive an on-line exam having a plurality of questions;
a module configured to present the questions to the student via an electronic screen display;
a module configured to provide the presentation options to the student, based upon the profile, during the presentation of the questions for the on-line exam; and
a module configured to receive answers to the questions and storing the answers.

7. The apparatus of claim 6 wherein the module configured to receive the on-line profile includes a module configured to receive parameters specifying the permitted presentation options for the particular student.

8. The apparatus of claim 6, further including a module configured to compile data relating to use of the presentation options and performance of the student in submitting answers to the questions.

9. The apparatus of claim 6, further including a module configured to provide a practice area for the student to submit answers to practice questions, not part of the on-line exam, using the presentation options.

10. An apparatus for converting an individual educational plan for a student into an on-line profile controlling presentation options for the student, comprising:
a module configured to receive an individual educational plan for a particular student;
a module configured to convert the individual educational plan into an on-line profile that controls presentation options available to the student when taking an on-line exam;
a module configured to receive the on-line exam having a plurality of questions;
a module configured to present the questions to the student via an electronic screen display;
a module configured to provide presentation options to the student, as controlled by the profile, during the presentation of the questions for the on-line exam; and
a module configured to receive answers to the questions and storing the answers.
